(19) United States
(12) Patent Application Publication
(10) Pub. No.: US 2026/0258918 A1
(43) Pub. Date: Sep. 3, 2026

(54) CLOUDS FOR ARTIFICIAL SKYLIGHTS AND WINDOWS

(71) Applicant: SIGNIFY HOLDING B.V., EINDHOVEN (NL)

(72) Inventors: MARTINUS HERMANUS WILHELMUS MARIA VAN DELDEN, VENLO (NL); SEBASTIAAN BATENBURG, BOXTEL (NL)

(21) Appl. No.: 18/881,812

(22) PCT Filed: Jul. 4, 2023
(86) PCT No.: PCT/EP2023/068293

§ 371 Date: Jan. 7, 2025

(30) Foreign Application Priority Data
Jul. 12, 2022 (EP) 22184293.3

(51) Int. Cl. F21S 8/06; F21V 3/04; F21V 7/00; F21V 9/02; F21V 9/40; F21V 11/06; F21V 14/04; F21V 23/04

(52) U.S. Cl. CPC F21S 8/06; F21V 3/049; F21V 7/0016; F21V 9/02; F21V 9/40; F21V 11/065; F21V 14/04; F21V 23/0442

(57) ABSTRACT

The invention provides a light generating system (1000) comprising an enclosure unit (400), a first light generating device (110), and one or more objects (440), wherein: the first light generating device (110) is configured to generate first device light (111) comprising visible light, wherein the visible light at least comprises blue light; the enclosure unit (400) comprises an enclosure wall (420) and an enclosure window (430) enclosing an enclosure space (410); wherein the enclosure wall (420) is configured to absorb at least part of the first device light (111) reaching the enclosure wall (420); and wherein the enclosure window (420) is translucent for the first device light (111) and scatters at least part of the blue light; the first light generating device (110) and the enclosure unit (400) are configured such that (i) the first device light (111) is provided in the enclosure space (410), and (ii) part of the first device light (111) escapes from the enclosure space (410) via the enclosure window (430); the one or more objects (440) are configured in the enclosure space (410) and are configured to reflect at least part of the first device light (111) reaching the one or more objects (440); the enclosure unit (400), the first light generating device (110), and the one or more objects (440) are configured such that at least part of the first device light (111) reaching the one or more objects (440) only reaches the one or more objects via reflection at the enclosure window (430).

### FIELD OF THE INVENTION

The invention relates to a light generating system, e.g. for providing artificial daylight. The invention further relates to space comprising the light generating system, e.g. for providing artificial daylight.

### BACKGROUND OF THE INVENTION

Systems generating artificial daylight are known in the art. For example, WO2014076656A1 describes a lighting system for illuminating an environment with lighting that simulates natural lighting, which includes: a first light source which emits a beam of visible light; a diffused-light generator delimited by an inner surface, which receive the light beam, and an outer surface, the diffused-light generator being at least partially transparent to the light beam. The diffused light generator transmits at least part of the light beam and emits through the outer surface, visible diffused light, the correlate color temperature (CCT) of the transmitted light being lower than the CCT of the visible diffused light. The lighting system includes a dark structure which is optically coupled to the environment via the diffused-light generator and provides a substantially uniform background to the first light source.

US2014/133125A1 discloses a lighting system for illuminating an environment with a lighting that simulates natural lighting. The system includes a first light source which emits a beam of visible light, a diffused-light generator delimited by an inner surface, which receives the light beam, and an outer surface. The diffused-light generator is at least partially transparent to the light beam. The diffused-light generator transmits at least part of the light beam and emits, through the outer surface, visible diffused light. The correlated color temperature of the transmitted light is lower than the correlated color temperature of the visible diffused light. The lighting system includes a dark box which hosts the first light source, and the dark box is optically coupled to the environment via the diffused-light generator.

### SUMMARY OF THE INVENTION

In current times, people may have to spend a lot of time indoors especially in situations where people may have to work or attend school from a home environment. Hence, it is very beneficial to have access or exposure to natural daylight in such environment. Natural daylight has a positive effect on an individual's health, especially in the production of Vitamin-D. Further, natural light may become increasingly important in the future where the current trend appears to promote working indoors. A solution may be the use of an artificial skylight which may provide an illusion of sunlight. Such existing artificial skylight, however, may not resemble an actual sky as objects such as clouds may be missing.

Hence, it is an aspect of the invention to provide an alternative light generating system for providing artificial daylight which preferably further at least partly obviates one or more of above-described drawbacks. The present invention may have as object to overcome or ameliorate at least one of the disadvantages of the prior art, or to provide a useful alternative.

According to a first aspect, the invention provides a light generating system comprising an enclosure unit, a first light generating device, and one or more objects. The first light generating device may in embodiments be configured to generate first device light. The first device light may especially comprise visible light. In specific embodiments, the visible light may at least comprise blue light. In embodiments, the enclosure unit may comprise an enclosure wall and an enclosure window enclosing an enclosure space. The enclosure wall may in embodiments be configured to absorb at least part of the first device light reaching the enclosure wall. In specific embodiments, the enclosure window may be translucent for the first device light. Additionally or alternatively, the enclosure window may scatter at least part of the blue light. In embodiments, the first light generating device and the enclosure unit may be configured such that the first device light may be provided in the enclosure space. Additionally or alternatively, part of the first device light may escape from the enclosure space via the enclosure window. The one or more objects may in embodiments be configured in the enclosure space. Especially, the one or more objects may be configured to reflect at least part of the first device light reaching the one or more objects. In embodiments, the enclosure unit, the first light generating device, and the one or more objects may be configured such that at least part of the first device light reaching the one or more objects only reaches the one or more objects via reflection at the enclosure window. Hence, in specific embodiments, the invention provides a light generating system comprising an enclosure unit, a first light generating device, and one or more objects, wherein: the first light generating device is configured to generate first device light comprising visible light, wherein the visible light at least comprises blue light; the enclosure unit comprises an enclosure wall and an enclosure window enclosing an enclosure space; wherein the enclosure wall is configured to absorb at least part of the first device light reaching the enclosure wall; and wherein the enclosure window is translucent for the first device light and scatters at least part of the blue light; the first light generating device and the enclosure unit are configured such that (i) the first device light is provided in the enclosure space, and (ii) part of the first device light escapes from the enclosure space via the enclosure window; the one or more objects are configured in the enclosure space and are configured to reflect at least part of the first device light reaching the one or more objects; the enclosure unit, the first light generating device, and the one or more objects are configured such that at least part of the first device light reaching the one or more objects only reaches the one or more objects via reflection at the enclosure window.

With this system one may—amongst others—create a connection to the outside world by mimicking the natural daylight from a (simulated) artificial skylight more realistically as the artificial skylight may comprise objects such as cloud-like objects (herein further also indicated as “clouds”). Also, the illusion of different kinds of weather conditions may be provided. This invention can be used in spaces where access to daylight is limited or absent, such as in office spaces, hospitality areas, and especially spaces deprived from access to natural light, such as underground spaces and control rooms. The invention may be used to help people maintain a connection to the dynamic natural world outside, thus making indoor environments with little or no daylight access more appealing by creating a realistic illusion of a skylight (or “roof light”) or window.

As indicated above, the invention provides a light generating system. Here, the term “light generating system” may especially refer to a single integral system, or to a plurality of (modular) enclosure units together forming a single system. Modular enclosure units are further discussed below. Hence, would a plurality of (modular) enclosure units be applied, especially these may be configured adjacent, such as at distances of equal to or less than 10 cm. In this way, the plurality of (modular) enclosure units may form a single system. The plurality of (modular) enclosure units may be physically connected to each other. In a specific embodiment, the invention provides a single integral system, including a shared housing and/or a shared exit window. Hence, the system may be perceived as a single system, which allows the system to provide a window like experience. The light generating system of the invention may especially be an artificial skylight or artificial window. Hence, the light generating system may provide the illusion of daylight in an indoor space.

The light generating system may comprise a first light generating device. The first light generating device may especially be configured to generate first device light. The first device light may especially comprise visible light. In specific embodiments, the visible light may comprise white light. In specific embodiments, the visible light may at least comprise blue light. In embodiments, the first device light may further comprise light having other wavelengths. The first device light is especially used for mimicking daylight, especially from an artificial window in a wall, slanted wall, room divider, roof, slanted roof, or ceiling, even more especially in a ceiling.

The light generating system may further comprise an enclosure unit. The enclosure unit may comprise any shape, such as in embodiments a cuboid, a parallelepiped, a prism, or a cylinder. However, the enclosure unit may in alternative embodiments comprise an irregular shape. In embodiments, the enclosure unit may have a length and a width each independently selected from the range of 20-200 cm, such as 40-100 cm. In embodiments, the enclosure unit may have a height selected from the range of 4-50 cm, such as 5-30 cm. In embodiments, the enclosure unit may enclose an enclosure space. See further also below about embodiments of enclosure volumes.

The enclosure unit may especially comprise an enclosure wall and an enclosure window. In embodiments, the enclosure space may essentially be defined by the enclosure wall and the enclosure window.

The enclosure wall may in embodiments be configured to absorb at least part of the first device light reaching the enclosure wall.

Especially, a light absorbing material has a light absorbance in the range of 50-100%, especially in the range of 70-100%, for light having a wavelength selected from the visible wavelength range. This may apply for a wavelength range of at least 100 nm, especially a wavelength range of at least 250 nm, such as a wavelength range of at least 300 nm (within the range of 380-780 nm). Hence, in specific embodiments, the enclosure wall may absorb at least 50%, such as at least 70%, like at least 85% of the first device light (or the second device light; see also below) reaching the enclosure wall perpendicularly. In more specific embodiments, the enclosure wall may absorb at least 90%, such as at least 95%, like at least 97% of the first (or second) device light reaching the enclosure wall perpendicularly.

In embodiments, the enclosure wall may be substantially uniform in absorbance. Especially, an absorbance of an area of at least 5 cm² of the enclosure wall may vary less than 20%, such as less than 15%, like less than 10% relative to an average absorbance of the enclosure wall. In embodiments, the enclosure wall may comprise a first enclosure wall part and a second enclosure wall part. Especially, the first enclosure wall part and the second enclosure wall part may be arranged in an embodiment at an angle of 90° but may in other embodiments be configured at an angle unequal to 90°, such as at an angle selected from the range of 45-95°. In further embodiments, a variation of absorbance of the first enclosure wall part may differ less than 20%, such as less than 15%, like less than 10% from an absorbance of the second enclosure wall part.

In embodiments, the enclosure wall may reflect less than 50%, such as less than 30%, like less than 20% of the first device light (or the second device light; see also below) reaching the enclosure wall perpendicularly. In more specific embodiments, the enclosure wall may reflect less than 10%, such as less than 5%, like less than 3% of the first (or second) device light reaching the enclosure wall perpendicularly.

Additionally or alternatively, the enclosure wall may be substantially uniform in reflectance. Especially, a variation in reflectance of the enclosure wall may be less than 20%, such as less than 15%, like less than 10% relative to an average reflectance of the enclosure wall (assuming perpendicular irradiation).

Additionally or alternatively, the enclosure wall may be substantially uniform in surface roughness. The surface roughness may be defined by the root mean square (RMS) roughness parameter. The root mean square roughness may be obtained by squaring each height value in the dataset, followed by taking the square root of the mean. Especially, a variation in surface roughness of the enclosure wall may be less than 20%, such as less than 15%, like less than 10% relative to an average RMS of the enclosure wall. In further embodiments, a variation of RMS of the first enclosure wall may differ less than 20%, such as less than 15%, like less than 10% from an RMS of the second enclosure wall.

In specific embodiments, the enclosure wall may be black. The enclosure wall may especially be rough, e.g. comprise matt black corner cubes, layer structures or comprise a matt black metal plate comprising a surface pattern such as a fine mesh of honeycombs. Such surface pattern may be embossed or indented in a metal surface. Alternatively, the enclosure wall may comprise other black materials such as a fabric, a plastic, or carbon. In embodiments, the enclosure wall may comprise a black coating. In specific embodiments, the enclosure wall may comprise carbon nanotubes, especially a carbon nanotubes comprising coating. Such materials may absorb (well) over 99% of incident visible light.

The enclosure window may in embodiments be translucent for the first device light. Especially, the enclosure window may in embodiments scatter at least part of the first device light, especially the enclosure window may scatter at least part of the blue light. In specific embodiments, the enclosure window may scatter all wavelengths in the visible wavelength range.

In specific embodiments, the enclosure wall and enclosure window may enclose the enclosure space. Hence, the enclosure wall may in embodiments function as a light absorbing optical cavity and the enclosure window may function as a light exit window. Further embodiments of the enclosure window will be discussed below.

As indicated above, the first light generating device and the enclosure unit may be configured such that the first device light is provided in the enclosure space. The enclosure space may have an enclosure space volume selected from the range of 1 dm³-2000 dm³, such as 5 dm³-1000 dm³, like 10 dm³-500 dm³.

Especially, part of the first device light may escape from the enclosure space via the enclosure window. In this way, the first device light may be absorbed by the enclosure wall or may exit the enclosure space (and hence enclosure unit) via the enclosure window. Therefore, in embodiments, the first device light that may be observed by an observer (outside the enclosure unit) may especially be scattered first device light.

The light generating system may further comprise one or more objects. The one or more objects may in embodiments be configured in the enclosure space and may be configured to reflect at least part of the first device light reaching the one or more objects. In this way, (part of) the first device light may in embodiments be absorbed and/or reflected by the one or more objects. Especially, first device light reflected by the one or more objects may then be absorbed by the enclosure wall or may exit the enclosure space (and hence enclosure unit) via the enclosure window. The one or more objects may provide a more realistic skylight and/or the possibility to mimic different weather conditions. The one or more objects may mimic one or more of a cloud, an airplane, vegetation and an animal, or any other object. The one or more objects may in embodiments comprise a 2-dimensional (2D) element. Additionally or alternatively, the one or more objects may comprise a 3-dimensional (3D) element.

As indicated above, in specific embodiments, the enclosure unit, the first light generating device, and the one or more objects may be configured such that at least part of the first device light reaching the one or more objects only reaches the one or more objects via reflection at the enclosure window. Such indirect irradiation of the one or more objects will be further discussed below. In alternative embodiments, at least part of the first device light reaching a part of the one or more objects may comprise direct irradiation. Such direct irradiation may result in optical effects, e.g. providing a silver lining to the object.

Here, the phrases “a wavelength in the visible wavelength range” “the wavelength” or “one or more wavelengths”, and similar phrases, may especially indicate one wavelength or multiple wavelengths. Hence, the terms “a wavelength” or “the wavelength” in phrases like “transparent for a wavelength” or “transmissive for the wavelength”, or “reflective for the wavelength”, and similar phrases, may especially refer to a plurality of wavelengths, such as a wavelengths in a wavelength range of at least 100 nm, especially in a wavelength range of at least 250 nm, such as in a wavelength range of at least 300 nm.

The phrase “light reaching an item”, and similar phrases, may in embodiments be defined as a part of the light actually reaching the item and hence may be (one or more of) reflected, absorbed or transmitted by the item. Hence, “first device light reaching the one or more objects” may in embodiments be defined as part of the first device light actually reaching the object that may be (one or more of) reflected, absorbed, or transmitted by the object. Hence, “first device light reaching the enclosure wall” may be defined as a part of the first device light actually reaching the enclosure wall that may be (one or more of) reflected, absorbed or transmitted by the enclosure wall. Hence, essentially the first device light may either reach the object, especially due to reflection via the enclosure window, be transmitted or scattered by the enclosure window, or be absorbed by the enclosure wall.

The transmission T (or light permeability) can be determined by providing light at a specific wavelength with a first intensity I₁ to the light transmissive material under perpendicular radiation and relating the intensity of the light I₂ at that wavelength measured after transmission through the material, to the first intensity of the light provided at that specific wavelength to the material, thus T=I₂/I₁. Likewise, the reflectivity R can be determined by relating the intensity of the light I₃ at that wavelength measured after reflection by the material, to the first intensity of the light I₁ provided at that specific wavelength to the material. Thus R=I₃/I₁. The absorbance A may in embodiments be defined as A=1−(T+R) (see also E-208 and E-406 of the CRC Handbook of Chemistry and Physics, 69^{th} edition, 1088-1989).

The enclosure window may in embodiments comprise nano particles having one or more dimensions selected from the range of 20-240 nm, more especially 40-180 nm, such as from the range of 60-150 nm, especially from the range 90-120 nm. In specific embodiments, the enclosure window may comprise a Rayleigh diffuser. In this way, the window may provide Rayleigh scattering from the first device light. In embodiments, the first device light may comprise white type light. Especially all wavelengths may be scattered, but blue light may be scattered more than red light. The process of Rayleigh scattering and its wavelength dependence has been described in WO2014076656A1, which is herein incorporated by reference. Hence, in specific embodiments, the enclosure window comprises nano particles having one or more dimensions selected from the range of 40-180 nm and wherein the first device light comprises white type light. Therefore, the enclosure window may be a Rayleigh scatterer for the first device light, and transmit part of the first device light and reflect (especially at least via scattering) part of the first device light.

In embodiments, the particles may have particle dimensions defined by smallest rectangular prisms circumscribing the respective particles, wherein such rectangular prism has a length D1, a width D2 and a height D3. In embodiments, one or more of D1, D2 and D3 may be selected from the range of 20-240 nm, more especially 40-180 nm, such as from the range of 60-150 nm, especially from the range 90-120 nm.

In embodiments, the particles may have equivalent spherical diameters D selected from the range of 20-240 nm, more especially 40-180 nm, such as selected from the range of 60-150 nm, especially from the range 90-120 nm.

The equivalent spherical diameter (or ESD) of an (irregularly) shaped object is the diameter of a sphere of equivalent volume. Hence, the equivalent spherical diameter (ESD) of a cube with a side a is

$$2 * a * \sqrt[3]{3 / ( 4 * π )} .$$

Would a sphere in an xyz-coordinate system with a diameter d be distorted to any other shape (in the xyz-plane), without changing the volume, than the equivalent spherical diameter of that shape would be d.

Particle sizes may be determined with methods known in the art, like one or more of optical microscopy, SEM and TEM. Dimensions may be number averaged, as known in the art. Further, the aspect ratios indicated above may refer to a plurality of particles having different aspect ratios. Hence, the particles may be substantially identical, but the particles may also mutually differ, such as two or more subsets of particles, wherein within the subsets the particles are substantially identical. The particles may have a unimodal particle size distribution or a polymodal size distribution.

The particles may thus mutually differ. For instance, the particles may have a distribution of the sizes of one or more of the particle length, the particle height, and an intermediate length. Therefore, in embodiments in average, the particles will have dimensions as described herein. For instance, at least 50 wt % of the particles may comply with the herein indicated dimensions (including ratios), such as at least 75 wt %, like at least 85 wt %. In alternative embodiments, at least 50% of the total number of particles may comply with the herein indicated dimensions (including ratios), such as at least 75%, like at least 85%.

As indicated above, in embodiments at least part of the first device light reaching the one or more objects may only reach the one or more objects via reflection at the enclosure window. To reduce the amount of direct irradiation of the one or more objects, the enclosure unit further comprise a first blocking element configured between the first light generating device and the one or more objects and configured to prevent direct irradiation of the one or more objects with at least part of the first device light. The first blocking element may increase the possibilities of arranging the first light generating device in the enclosure space, while nevertheless preventing a direction irradiation of the one or more objects by the first light generating device. The blocking element may e.g. comprise matt black corner cubes, layer structures or comprise a matt black metal plate comprising a surface pattern such as a fine mesh of honeycombs. Such surface pattern may be embossed or indented in a metal surface. Alternatively, the blocking element may comprise other black materials such as a fabric, a plastic, or carbon.

Especially, the first blocking element may absorb at least 50%, such as at least 70%, like at least 85% of the first (or second) device light reaching the first blocking element perpendicularly. In more specific embodiments, the first blocking element may absorb at least 90%, such as at least 95%, like at least 97% of the first (or second) device light reaching the first blocking element perpendicularly. Embodiments described for the enclosure wall may also apply to the first blocking element. Materials and coatings as described above may also apply for the blocking element.

Hence, the enclosure unit further comprises a first blocking element, configured between the first light generating device and the one or more objects, and configured to prevent direct irradiation of the one or more objects with at least part of the first device light.

Especially, the first light generating device and the first blocking element may in embodiments be configured such that less than 10%, such as less than 5%, like less than 2% of a total spectral power in the visible wavelength range of first device light reaching the one or more objects is direct light. Additionally or alternatively, at least 90%, such as at least 95%, like at least 98% of the of the total spectral power in the visible wavelength range of first device light reaching the one or more objects may in embodiments be indirect light. In this way, the object may have a desired level of brightness. Especially, the sum of the first device light reaching the one or more objects indirectly and the first device light reaching the one or more objects directly may be 100%. Hence, in specific embodiments, the first light generating device and the first blocking element are configured such that less than 5% of a total spectral power of first device light reaching the one or more objects is direct light and at least 95% of the of the total spectral power of first device light reaching the one or more objects is indirect light.

The first device light may in embodiments have a first optical axis (O1). Especially, the first optical axis (O1) and the enclosure window have a mutual first angle (α1). In embodiments, the first light generating device may be configured such that the first angle (α1) may be selected from the range of 5-85°, such as 10-80°, like 15-75°. In this way, the relative amounts of reflection and scattering of the first device light may provide an improved daylight mimic. Hence, in specific embodiments the first device light has a first optical axis (O1), wherein the first optical axis (O1) and the enclosure window have a mutual first angle (α1), wherein the first angle (α1) is selected from the range of 10-80°.

In further embodiments, the first light generating device and the enclosure window may be configured such that at least 10%, such as at least 20%, like at least 30% of a spectral power in the visible wavelength range of the first device light reaching the enclosure window may be transmitted through the enclosure window. In this way, the light generating device may provide sufficient spectral power to an observer. Additionally or alternatively, the first light generating device and the enclosure window may be configured such that at least 10%, such as at least 20%, like at least 30% of the spectral power in the visible wavelength range of the first device light reaching the enclosure window may be reflected by the enclosure window. In further embodiments, the first light generating device and the enclosure window may be configured such that less than 15%, such as less than 10%, like less than 5% of the spectral power in the visible wavelength range of the first device light reaching the enclosure window may be absorbed by the enclosure window. In this way, there may be sufficient spectral power to provide indirect irradiation of the one or more objects configured in the enclosure space. Especially, the sum of the first device light reaching the enclosure window that is reflected by the enclosure window and the first device light reaching the enclosure window that is transmitted by the enclosure window may be at maximum 100% (and may especially be at least about 95%). Hence, in specific embodiments the first light generating device and the enclosure window are configured such that (i) at least 20% of a spectral power of the first device light reaching the enclosure window is transmitted through the enclosure window and (ii) at least 20% of the spectral power of the first device light reaching the enclosure window is reflected by the enclosure window.

In embodiments, at least one of the objects may be irregularly shaped. In this way, the object may better mimic a natural object such as a cloud or vegetation as such natural object may also be irregularly shaped. Additionally or alternatively, three or more objects may in embodiments not be arranged in a regular pattern. E.g. in an embodiment three objects may be arranged in the shape of an isosceles triangle. In alternative embodiments, the three or more objects may be arranged in a line at a non-equidistant spacing. However, other arrangements are also possible. Hence, in specific embodiments, the one or more objects applies one or more of: (i) at least one of the objects is irregularly shaped, and (ii) three or more objects are not arranged in a regular pattern. In more specific embodiments, at least one of the objects may have the shape of a cloud. In such embodiments, alternating between the three or more objects may provide a changing view or scenery in the system. Such shapes and/or patterns may improve the illusion of an actual skylight or window.

In embodiments, the one or more objects may comprise a combined object volume of 1-25%, like 2-20%, such as 4-15% of the enclosure space volume.

In further embodiments, at least one of the objects may comprise a wad of wool such as cotton wool, glass wool, metal wool, plastic wool, crumbled paper, crumbled fabric, crumbled metal foil, or fibrous pads. Additionally or alternatively, at least one of the objects may comprise a (porous) foam, a plastic foil, a plastic sheet, or paper. Hence, in specific embodiments, at least one of the objects comprises a wad of wool. In embodiments, at least one of the objects may be white. Additionally or alternatively, at least one of the objects may be grey. In embodiments, at least one of the objects may be transmissive. Additionally or alternatively, at least one of the objects may be translucent. In embodiments, wherein the light generating system comprises a plurality of objects, at least one of the objects may have different spectral properties from at least one other object. In alternative embodiments, the one or more objects may comprise identical spectral properties. In specific embodiments, all objects may be white. In alternative embodiments, all objects may be grey. Additionally or alternatively, all objects may be transmissive. In specific embodiments, all objects may be translucent.

In embodiments, the first light generating device may have a controllable spectral power distribution of the first device light. Especially, the controllable spectral power distribution of the first device light may include one or more different spectral power distributions of white type light. Hence, in specific embodiments, the first light generating device has a controllable spectral power distribution of the first device light, including one or more different spectral power distributions of white type light. In embodiments, the first light generating device may comprise a single first light source, such as a single LED. In alternative embodiments, the first light generating device may comprise a first array of first light sources. Especially, one or more of the first light sources may be individually controllable. In this way, a changing weather pattern, such as sun and clouds, may be imitated by irradiating varying parts of the one or more objects.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL. In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

In specific embodiments, correlated color temperatures (CCT) of a first type of first device light and a second type of first device light may be different when the respective CCTs of the first type of light and the second type of light differ with at least 500 K, such as at least 750 K, like in embodiments at least 1000 K.

For controlling the spectral power distribution of the first device light, the light generating system may further comprise a control system. In embodiments, the control system may be configured to control the first light generating device, especially in dependence of one or more of an input signal of a user interface, a sensor signal (of a sensor), and a timer. Hence, in specific embodiments, the light generating system further comprises a control system, wherein the control system is configured to control the first light generating device in dependence of one or more of an input signal of a user interface, a sensor signal, and a timer. In this way, the spectral power distribution of the first device light may be adjusted to better mimic the current local weather conditions and/or circadian appearance of daylight.

The light generating system may in embodiments further comprise a second light generating device. Especially, the second light generating device may be configured to generate second device light comprising visible light. In embodiments, the second device light may comprise white light. Embodiments of “white light”, CCT, and CRI described above for first device light may also apply for second device light. In other embodiments, the second device light may comprise colored light. The second light generating device may in embodiments have a controllable spectral power distribution of the second device light, including one or more spectral power distributions of white light and/or one or more spectral power distributions of colored light.

In embodiments, the second light generating device and the enclosure unit may be configured such that the second device light may be provided in the enclosure space. Additionally or alternatively the second light generating device and the enclosure unit may be configured such that part of the second device light may escape from the enclosure space via the enclosure window. The enclosure unit, the second light generating device, and the one or more objects may in embodiments be configured such that at least part of the second device light reaching the one or more objects only reaches the one or more objects directly. Hence, in specific embodiments the light generating system further comprises a second light generating device, wherein the second light generating device is configured to generate second device light comprising visible light; the second light generating device and the enclosure unit are configured such that (i) the second device light is provided in the enclosure space, and (ii) part of the second device light escapes from the enclosure space via the enclosure window; and the enclosure unit, the second light generating device, and the one or more objects are configured such that at least part of the second device light reaching the one or more objects only reaches the one or more objects directly. The second light may especially be used for providing the illusion of different kinds of weather and circadian appearance by directly illuminating one or more objects. In further embodiments, the second light generating device may comprise a plurality of different light generating devices.

In embodiments, during operation the spectral power distribution of the first device light and the second device light may differ (see further also below).

More specifically, the second light generating device, and the one or more objects may in embodiments be configured such that at least 50%, such as at least 60%, like 70% of a total spectral power in the visible wavelength range of second device light reaching the one or more objects is direct light. Additionally or alternatively, the second light generating device, and the one or more objects may in embodiments be configured such that less than 50%, such as less than 40%, like less than 30% of the of the total spectral power in the visible wavelength range of second device light reaching the one or more objects is indirect light. The percentages mentioned here may especially refer to the spectral power of second device light that actually reaches the one or more objects. Hence, spectral power of second device light that does not reach the one or more objects may not be taken into account here. Further, as the enclosure walls may be highly absorbing for the second device light, not the entire surface area of the one or more objects may be receiving spectral power of second device light. Hence, in specific embodiments, the second light generating device, and the one or more objects are configured such at least 60% of a total spectral power of second device light reaching the one or more objects is direct light, and less than 40% of the of the total spectral power of second device light reaching the one or more objects is indirect light.

In further embodiments, the second light generating device and the enclosure window may be configured such that at least 15%, like at least 20%, such as at least 30% of a spectral power in the visible wavelength range of the second device light reaching the enclosure window may be transmitted through the enclosure window. Additionally or alternatively, the second light generating device and the enclosure window may be configured such that at least 15%, like at least 20%, such as at least 30% of the spectral power in the visible wavelength range of the second device light reaching the enclosure window is reflected by the enclosure window. Hence, in specific embodiments, the second light generating device and the enclosure window are configured such that (i) at least 20% of a spectral power of the second device light reaching the enclosure window is transmitted through the enclosure window and (ii) at least 20% of the spectral power of the second device light reaching the enclosure window is reflected by the enclosure window.

As indicated above, in embodiments the light generating system may further comprise a control system. Especially, the control system may be configured to control one or more of the first light generating device and the second light generating device in dependence of one or more of an input signal of a user interface, a sensor signal (of a sensor), and a timer. In this way, the light generating may better mimic different weather conditions. Hence, in specific embodiments the light generating system further comprises a control system, wherein the control system is configured to control the first light generating device and the second light generating device in dependence of one or more of an input signal of a user interface, a sensor signal, and a timer.

In embodiments, the second light generating device may be configured to generate white second device light. In other embodiments, the second light generating device may be configured to generate colored second device light. Especially, the first light generating device and the second light generating device each have an operational mode wherein a spectral power distribution of the first device light and a spectral power distribution of the second device light differ. For instance, they may differ in one or more of color point and correlated color temperature.

Especially, in embodiments one or more of the user interface, the sensor signal and the timer may in embodiments provide the input signal for the control system to configure a color of the second device light. The user interface may enable to manually change the color of the second device light to circadian appearance. Additionally or alternatively, the sensor signal or the timer may automatically adapt the color of the second device light to circadian appearance. Further, the user interface and/or the sensor signal may be used to adapt the color of the second device light to current weather conditions.

In specific embodiments, colors or color points of a first type of light and a second type of light may be different when the respective color points of the first type of light and the second type of light differ with at least 0.01 for u′ and/or with at least 0.01 for v′, even more especially at least 0.02 for u′ and/or with at least 0.02 for v′. In yet more specific embodiments, the respective color points of first type of light and the second type of light may differ with at least 0.03 for u′ and/or with at least 0.03 for v′. Here, u′ and v′ are color coordinates of the light in the CIE 1976 UCS (uniform chromaticity scale) diagram.

Spectral power distributions of different sources of light having centroid wavelengths differing least 10 nm, such as at least 20 nm, or even at least 30 nm may be considered different spectral power distributions, e.g. different colors. In general, the differences in centroid wavelengths will not be larger than about 400 nm, such as not more than 350 nm.

In specific embodiments, correlated color temperatures (CCT) of the first device light and of the second device light may be different, differing with at least 500 K, such as at least 750 K, like in embodiments at least 1000 K.

In operational modes of the system, the first device light is white light and the second device light is white light. In (other) embodiments, the first device light is white light and the second device light is white light, wherein the first device light and the second device light have different correlate color temperatures. In other operational modes of the system, the first device light is white light and the second device light is colored light. In yet other operational modes of the system, the first device light is white light and the second device light is light having a spectral power distribution varying with time. In specific embodiments, other operational modes of the system, the first device light is white light and the second device light comprises one or more of a color of a dayspring and a sunset sky. In specific embodiments, the second device light may be white light to mimic a bright sunny day. In other embodiments, the second device light may be pink to mimic pinkish clouds at night.

Colored light may e.g. be violet light, indigo light, blue light, cyan light, green light, yellow light, orange light, or red light. The terms “violet light” or “violet emission”, and similar terms, may especially relate to light having a wavelength in the range of about 380-440 nm. In specific embodiments, the violet light may have a centroid wavelength in the 380-440 nm range. The terms “blue light” or “blue emission”, and similar terms, may especially relate to light having a wavelength in the range of about 440-490 nm (including some violet and cyan hues). In specific embodiments, the blue light may have a centroid wavelength in the 440-490 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range.

The light generating system may in embodiments further comprise a first grid. The first grid may especially be configured downstream of the enclosure window. Hence, the first grid may be configured external of the enclosure. In alternative (or additional) embodiments, the first grid may be configured directly upstream of the enclosure window.

The first grid may especially comprise a first grid structure and first grid openings. The first grid openings may especially be defined by the first grid structure. In embodiments, the first grid structure may be configured to block part of the first device light and the first grid openings may be configured to allow first device light propagate through. In embodiments, blocking part of the first device light may comprise absorbing or reflecting part of the first device light. Especially, blocking part of the first device light may be explained as hiding part of the enclosure window from an observer. The part of the enclosure window that may be hidden, may especially depend on the position of the observer. In this way, a view of an artificial sky by the observer may change in case the observer is moving, as a different angle of view may result in different parts of blocked enclosure window.

Hence, in specific embodiments, the light generating system further comprises a first grid configured downstream of the enclosure window or directly upstream of the enclosure window, wherein the first grid comprises a first grid structure and first grid openings, wherein the first grid structure is configured to block part of the first device light and wherein the first grid openings are configured to allow first device light propagate through.

The first grid structure may comprise a plurality of first grid structure elements. In embodiments, the first grid structure may comprise a regular pattern, such as comprising an array of regularly shaped first grid openings, separated by the first grid structure elements. In alternative embodiments, the first grid may comprise an irregular pattern, such as comprising irregularly shaped grid openings, separated by the first grid structure elements. The first grid structure may in embodiments be one or more of reflective, transmissive, or opaque for first (or second) device light. Additionally or alternatively, the first grid structure may be white. In other embodiments, the first grid structure may have other colors. The first grid structure may in embodiments comprise any shape.

In embodiments comprising the second device, the first grid structure may also be configured to block part of the second device light and the first grid openings may be configured to also allow second device light propagate through. Especially, such first grid may provide a feeling of perspective to the user.

In embodiments, the first grid structure may have a length corresponding to the length or width of the enclosure unit. Hence, in specific embodiments, the length of the first grid structure may be selected from the range of 20-200 cm, such as 40-100 cm. In alternative embodiments, the first grid structure may be smaller than the enclosure unit, in such embodiments the first grid structure may have a length selected from the range of 3-100 cm, like 5-50 cm. In embodiments, the first grid structure may have a height selected from the range of 2-20 cm, such as 3-10 cm. In embodiments, the first grid structure elements may have a width (or thickness) selected from the range of 0.1-2 cm, such as 0.5-1 cm. In specific embodiments, the first grid structure elements may have a constant width (or thickness). In such embodiments, the first grid structure elements may be parallel. In alternative embodiments, the width (or thickness) of the first grid structure elements may differ at different positions. In such embodiments, the first grid structure elements may be tapered.

In embodiments, the light generating system may further comprise a diffusor. The diffusor may especially be configured downstream of the enclosure window. Alternatively, the diffusor may be configured directly upstream of the enclosure window. The diffusor may in embodiments be configured to diffusively transmit at least part of the first device light and the optional second device light reaching the diffusor. Hence, in specific embodiments the light generating system further comprises a diffusor configured downstream of the enclosure window or directly upstream of the enclosure window, configured to diffusively transmit at least part of the first device light reaching the diffusor. The diffusor may especially provide a more homogenous exterior illumination. Would both a first grid and a diffusor be available, especially the first grid may be configured downstream of the diffusor.

In embodiments, at least one of the one or more objects may be configured movable in the enclosure. Hence, in specific embodiments the light generating system may in embodiments further comprise a first actuator. Especially, the first actuator may be configured to move the at least one (i.e. one or more movable objects) of the one or more objects within the enclosure. In embodiments, the one or more objects may be configured on a carrier such as an endless loop or a rotating wheel. In such embodiments, the first actuator may be configured to move the carrier and hence move the one or more objects. However, other embodiments may also be possible.

In further embodiments, a control system may be configured to control the first actuator in dependence of one or more of an input signal of a user interface, a sensor signal (of a sensor), and a timer. Hence, in specific embodiments the light generating system further comprises a first actuator, wherein at least one of the one or more objects is configured movable in the enclosure; and the first actuator is configured to move the at least one of the one or more objects within the enclosure. In this way, at least one of the one or more objects may be displaced. In embodiments, the object may move within the enclosure space. In this way, the light generating system may dynamically mimic the sky. In further embodiments, at least one of the one or more objects may be displaceable in a way that may obscure the object. The object may for e.g. be moved behind a shield or into a cavity within the enclosure space. In this way, the light generating system may show one or more objects at one time and show fewer objects at another time. By using such a first actuator, the skylight may be continuously adaptable.

In embodiments, the light generating system may further comprise a second grid. In embodiments, the second grid may be configured static in the enclosure.

During operation of the light generating system, at least part of the time the second grid may be configured upstream of the enclosure window and downstream of the one or more objects. The second grid may especially comprise a second grid structure and second grid openings defined by the second grid structure. In embodiments, the second grid structure may be configured to block part of the first device light reflected at the one or more objects and wherein the second grid openings are configured to allow part of the first device light reflected at the one or more objects propagate through. The second grid structure may comprise second grid structure elements. Further embodiments described for the first grid may also apply to the second grid.

In alternative embodiments, the second grid may especially be configured movable in the enclosure. In such embodiments, the light generating system may further comprise a second actuator. The second actuator may especially be configured to move the second grid within the enclosure. By using such a second actuator, the skylight may be continuously adaptable. In further embodiments, the light generating system may comprise a control system, wherein the control system may be configured to control the second actuator. Especially, the second actuator may control the (movable) second grid in dependence of one or more of an input signal of a user interface, a sensor signal (of a sensor), and a timer. Especially one or more of the user interface, the sensor signal and the timer may in embodiments provide the input signal for the control system to configure a configuration of the second grid. The user interface may enable to manually change configuration of the second grid to weather conditions. Additionally or alternatively, the sensor signal or the timer may automatically adapt the configuration of the second grid to weather conditions. Further, the user interface and/or the sensor signal may be used to adapt configuration of the second grid to weather conditions. Especially, depending on the configuration of the second grid, objects may be hidden within the enclosure unit (hidden for the observer) or may be exposed within the enclosure unit (visible for the observer). Hence, in specific embodiments the light generating system further comprises a second grid and a second actuator, wherein: the second grid is configured movable in the enclosure; during operation, at least part of the time the second grid is configured upstream of the enclosure window and downstream of the one or more objects; the second grid comprises a second grid structure and second grid openings, wherein the second grid structure is configured to block part of the first device light reflected at the one or more objects and wherein the second grid openings are configured to allow part of the first device light reflected at the one or more objects propagate through; and the second actuator is configured to move the second grid within the enclosure.

In embodiments, second grid may be configured on a carrier such as an endless loop or a rotating wheel. In this way, the second actuator may be configured to move the carrier and hence move the second grid. However, other embodiments may also be possible.

In this way, a continuously adaptable light generating system may be provided as different (parts of) objects may be visible for an observer through the second grid.

Especially, the use of a user interface, a sensor signal or a timer may facilitate to adapt the appearance of the light generating system in relation to external stimuli. In embodiments, the light generating system may comprise a plurality of second grids, wherein the second grids may differ in one or more of moving speed and moving direction. In embodiments, the second grid may be replaceable or changeable. This may allow to (manually) change the visible pattern of the one or more objects.

As indicated above, the enclosure unit may be a modular enclosure unit. In such embodiments, the light generating system may comprise a plurality of modular enclosure units. In embodiments, the light generating system may comprise one or more enclosure walls between two modular enclosure units. Additionally or alternatively, in embodiments there may be no enclosure wall between two modular enclosure units. Especially, the light generating system comprising a plurality of modular enclosure units may in embodiments comprise a master control unit. Such master control unit may in embodiments be configured to control a plurality of modular enclosure units and the light generating devices therein.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In a further aspect, the invention may provide a space. The space may in embodiments comprise one or more of a wall, slanted wall, room divider, roof, slanted roof and ceiling. Especially the space may further comprise the light generating system suspended from the roof, slanted roof or ceiling. In this way, the light generating system may function as a skylight illusion. Additionally or alternatively, the space may comprise the light generating system attached to a wall, slanted wall or room divider. In this way, the light generating system may function as a window illusion. Hence, in an aspect, the invention provides a space comprising a ceiling, wherein the space further comprises the light generating system suspended from the ceiling.

The term “space” may for instance relate to a (part of) hospitality area, such as a restaurant, a hotel, a clinic, or a hospital, etc. The term “space” may also relate to (a part of) an office, a department store, a warehouse, a cinema, a church, a theatre, a library, etc. However, the term “space” may also relate to (a part of) a working space in a vehicle, such as a cabin of a truck, a cabin of an air plane, a cabin of a vessel (ship), a cabin of a car, a cabin of a crane, a cabin of an engineering vehicle like a tractor, a cabin of a train carriage, etc. The term “space” may also relate to (a part of) a working space, such as an office, a (production) plant, a power plant (like a nuclear power plant, a gas power plant, a coal power plant, etc.), etc. For instance, the term “space” may also relate to a control room, a security room, etc. Especially, the term “space” may herein refer to an indoor space. In yet other embodiments, the term “space” may also relate to a toilet room or bathroom. In yet other embodiments, the term “space” may also relate to an elevator. In embodiments, the term “space” may also refer to a conference room, a school room, an indoor hallway, an indoor corridor, an indoor space in an elderly home, an indoor space in a nursing home, etc. In embodiments, the term “space” may refer to an indoor sport space, like a gym, a gymnastics hall, in indoor ball sport space, a ballet room, a swimming pool, a changing room, etc. In embodiments, the term “space” may refer to an (indoor) bar, an (indoor) disco, etc.

In yet further embodiments, the invention may provide a use of the lighting system for office lighting, hospitality area lighting, domestic lighting, station lighting, or internal vehicle lighting. However, other applications may also be possible.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm. The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In yet a further aspect, the invention also provides a lamp or a luminaire comprising the light generating system as defined herein. The luminaire may further comprise a housing, optical elements, louvres, etc. etc. . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a light generating device selected from the group of a lamp, a luminaire, a projector device, a disinfection device, a photochemical reactor, and an optical wireless communication device, comprising the light generating system as defined herein. The light generating device may comprise a housing or a carrier, configured to house or support, one or more elements of the light generating system.

Instead of the terms “lighting device” or “lighting system”, and similar terms, also the terms “light generating device” or “light generating system”, (and similar terms), may be applied. A lighting device or a lighting system may be configured to generate device light (or “lighting device light”) or system light (“or lighting system light”). As indicated above, the terms light and radiation may interchangeably be used.

As indicated above, the light generating system comprises a first light generating device and optionally a second light generating device. Some aspects of light generating devices are described below.

A light generating device may especially be configured to generate device light. Especially, the light generating device may comprise a light source. The light source may especially configured to generate light source light. In embodiments, the device light may essentially consist of the device light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chip-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The term “light source” may also refer to a chip scaled package (CSP). A CSP may comprise a single solid state die with provided thereon a luminescent material comprising layer. The term “light source” may also refer to a midpower package. A midpower package may comprise one or more solid state die(s). The die(s) may be covered by a luminescent material comprising layer. The die dimensions may be equal to or smaller than 2 mm, such as in the range of e.g. 0.2-2 mm. Hence, in embodiments the light source comprises a solid state light source. Further, in specific embodiments, the light source comprises a chip scale packaged LED. Herein, the term “light source” may also especially refer to a small solid state light source, such as having a mini size or micro size. For instance, the light sources may comprise one or more of mini LEDs and micro LEDs. Especially, in embodiment the light sources comprise micro LEDs or “microLEDs” or “μLEDs”. Herein, the term mini size or mini LED especially indicates to solid state light sources having dimensions, such as die dimension, especially length and width, selected from the range of 100 μm-1 mm. Herein, the term p size or micro LED especially indicates to solid state light sources having dimensions, such as die dimension, especially length and width, selected from the range of 100 μm and smaller.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc. . . . The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a diode laser, or a superluminescent diode.

The term “centroid wavelength”, also indicated as kc, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σλ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-1B schematically depicts some general aspects of the light generating system;

FIGS. 2-4 schematically depict some further aspects of the light generating system;

FIG. 5 schematically depicts some detailed aspects of embodiments; and

FIG. 6 schematically depicts an application of the invention.

The schematic drawings are not necessarily to scale.

### DETAILED DESCRIPTION OF THE EMBODIMENTS

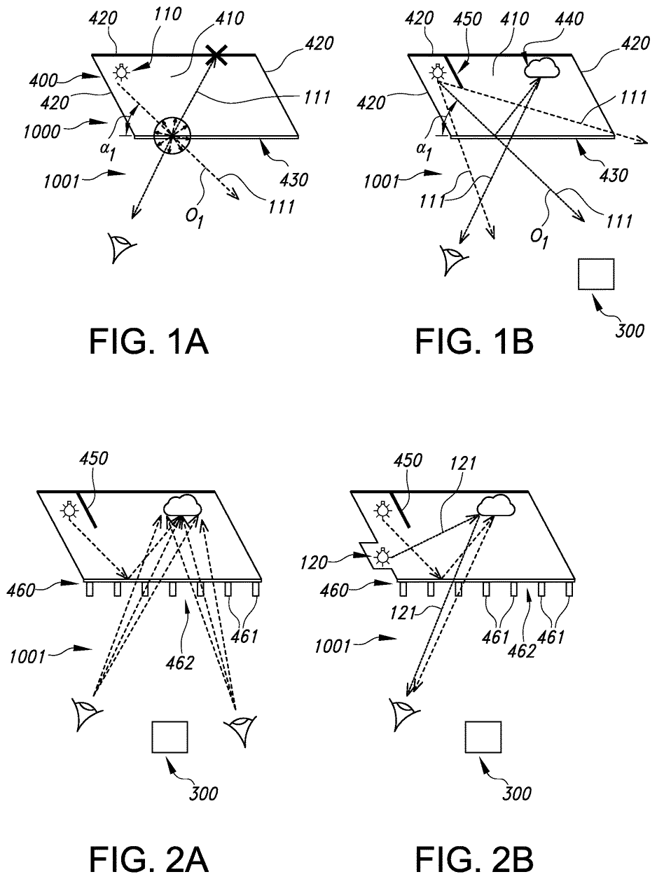

FIG. 1a schematically depicts a cross section of a light generating system 1000 comprising an enclosure unit 400 and a first light generating device 110. The first light generating device 110 may be configured to generate first device light 111. In embodiments, the first device light 111 may comprise visible light, wherein the visible light may at least comprise blue light. The depicted enclosure unit 400 comprises an enclosure wall 420 and an enclosure window 430 enclosing an enclosure space 410. Especially, the enclosure wall 420 may be configured to absorb at least part of the first device light 111 reaching the enclosure wall 420, here indicated by a cross. In specific embodiments, the enclosure wall 420 may be black. In this way, the inner works of the enclosure unit may not be visible to an observer. Especially, the enclosure window 430 may be translucent for the first device light 111 and may scatter at least part of the blue light, indicated by arrows. In embodiments, the first light generating device 110 and the enclosure unit 400 may be configured such that the first device light 111 may be provided in the enclosure space 410 and part of the first device light 111 may escapes from the enclosure space 410 via the enclosure window 430. The part of the first device light 111 that escapes from the enclosure space 410 may be defined as system light 1001 which may be observed by the observer.

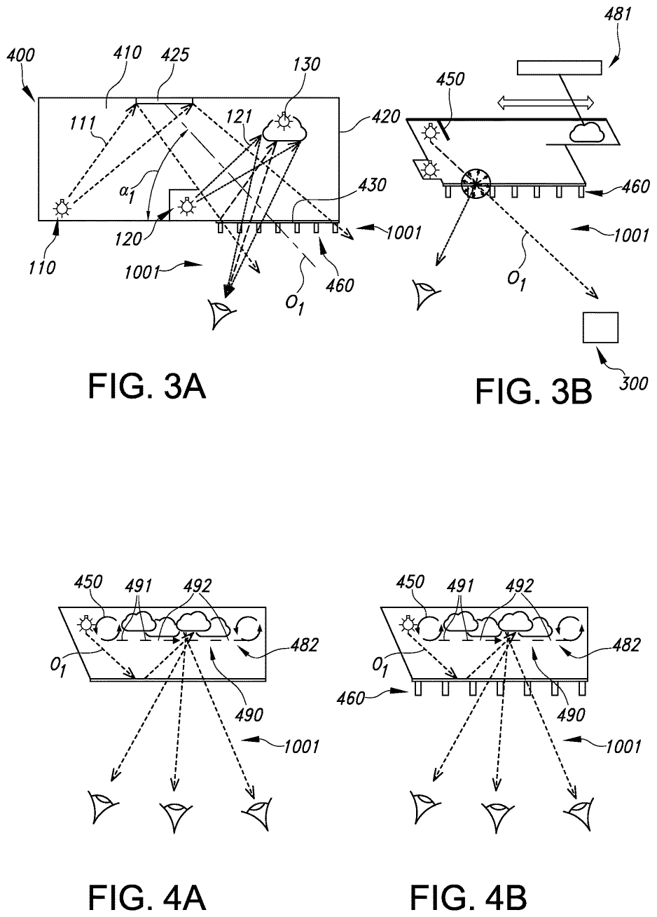

FIG. 1b schematically depicts an embodiment of the invention wherein one or more objects 440 may be configured in the enclosure space 410. The one or more objects may be configured to reflect at least part of the first device light 111 reaching the one or more objects 440. In the depicted embodiment, the enclosure unit 400, the first light generating device 110, and the one or more objects 440 are configured such that at least part of the first device light 111 reaching the one or more objects 440 only reaches the one or more objects 440 via reflection at the enclosure window 430. In embodiments, the light generating system may comprise a control system 300. Especially, the control system 300 may be configured to control the first light generating device 110 in dependence of one or more of an input signal of a user interface, a sensor signal (of a sensor), and a timer. In further embodiments, the first light generating device 110 may have a controllable spectral power distribution of the first device light 111. The controllable spectral power distribution of the first device light 111 may especially include one or more different spectral power distributions of white type light. The enclosure unit 420 of depicted embodiment comprises a first blocking element 450. The first blocking element 450 will be further described in relation to FIG. 2a.

In the depicted embodiment, at least one of the objects 440 has the shape of a cloud. In further embodiments, at least one of the objects 440 may comprise a wad of wool such as cotton wool, glass wool, metal wool, plastic wool, crumbled paper, crumbled fabric, crumbled metal foil, or fibrous pads.

FIGS. 1a and b further depict the first device light 111 having a first optical axis (O1). Especially, the first optical axis (O1) and the enclosure window 430 have a mutual first angle (α1). In embodiments, the first angle (α1) may be selected from the range of 5-85°, such as 10-80°, like 15-75°. In specific embodiments, the first light generating device 110 and the enclosure window 430 may be configured such that (i) at least 20% of a spectral power (in the visible wavelength range) of the first device light 111 reaching the enclosure window 430 may be transmitted through the enclosure window 430 and (ii) at least 20% of the spectral power (in the visible wavelength range) of the first device light 111 reaching the enclosure window 430 may be reflected by the enclosure window 430.

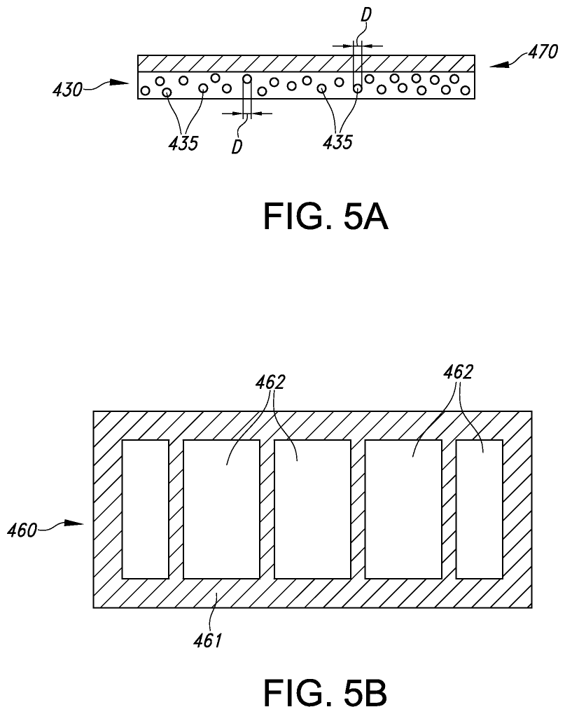

FIG. 2a schematically depicts an embodiment of the light generating system 1000 wherein the enclosure unit 400 further comprises a first blocking element 450. The first blocking element 450 may especially be configured between the first light generating device 110 and the one or more objects 440 and configured to prevent direct irradiation of the one or more objects 440 with at least part of the first device light 111. In specific embodiments, the first light generating device 110 and the first blocking element 450 may be configured such that less than 5% of a total spectral power (in the visible wavelength range) of first device light 111 reaching the one or more objects 440 is direct light and at least 95% of the of the total spectral power (in the visible wavelength range) of first device light 111 reaching the one or more objects 440 is indirect light. In the depicted embodiment, the light generating system 1000 further comprises a first grid 460 configured downstream of the enclosure window 430. In alternative embodiments, the first grid 460 may be configured directly upstream of the enclosure window 430. The first grid 460 comprises a first grid structure 461 and first grid openings 462 defined by the first grid structure 461, see FIG. 5b for more details. The first grid structure 461 may especially be configured to block part of the first device light 111 and the first grid openings 462 may especially be configured to allow first device light 111 to propagate through.

FIG. 2b schematically depicts an embodiment of the light generating system 1000, further comprising a second light generating device 120. The second light generating device 120 may especially be configured to generate second device light 121 comprising visible light. In embodiments, the second light generating device 120 and the enclosure unit 400 may be configured such that the second device light 121 is provided in the enclosure space 410, and part of the second device light 121 escapes from the enclosure space 410 via the enclosure window 430. In embodiments, the second light generating device 120 may have a controllable spectral power distribution of the second device light 121, including one or more spectral power distributions of white light. In further embodiments, the enclosure unit 400, the second light generating device 120, and the one or more objects 440 may be configured such that at least part of the second device light 121 reaching the one or more objects 440 only reaches the one or more objects 440 directly. In embodiments, the second light generating device 120 and the enclosure window 430 may be configured such that at least 20% of a spectral power (in the visible wavelength range) of the second device light 121 reaching the enclosure window 430 is transmitted through the enclosure window 430 and at least 20% of the spectral power (in the visible wavelength range) of the second device light 121 reaching the enclosure window 430 is reflected by the enclosure window 430. In specific embodiments wherein the light generating system 1000 comprises the second light generating device 120 and a first grid 460, the first grid structure 461 may also be configured to block part of the second device light 121 and the first grid openings 462 may be configured to also allow second device light 111 propagate through. As indicated above, the light generating system may further comprise a control system 300. In specific embodiments, the control system 300 is configured to control the first light generating device 110 and the second light generating device 120 in dependence of one or more of an input signal of a user interface, a sensor signal (of a sensor), and a timer.

FIG. 3a schematically depicts an alternative configuration wherein the first light generating device is configurated such that the first device light 111 may only exit the enclosure space 410 after being reflected by a reflector 425. The reflector 425 may comprise a mirror or metal surface. In this way, a larger part of first device light 111 reaching the one or more objects 440 may be indirect light. In the depicted embodiment, the second light generating device 120 is configured to provide direct second device light 121 to the one or more objects. In specific embodiments, the enclosure unit 400, the second light generating device 120, and the one or more objects 440 may be configured such at least 60% of a total spectral power (in the visible wavelength range) of second device light 121 reaching the one or more objects 440 is direct light, and less than 40% of the of the total spectral power (in the visible wavelength range) of second device light 111 reaching the one or more objects 440 is indirect light.

FIG. 3b schematically depicts an embodiment of the light generating system 1000 wherein the light generating system 1000 further comprises a first actuator 481. In such embodiments, at least one of the one or more objects 440 may configured movable in the enclosure 410. Especially, the first actuator 481 may be configured to move the at least one of the one or more objects 440 within the enclosure 410 wherein a control system 300 is configured to control the first actuator 481 in dependence of one or more of an input signal of a user interface, a sensor signal (of a sensor), and a timer.

FIGS. 4a and b schematically depict an embodiment wherein for the one or more objects 440 applies one or more of: (i) at least one of the objects 440 is irregularly shaped, and (ii) three or more objects are not arranged in a regular pattern. In the depicted embodiment, the light generating system 1000 further comprises a second grid 490 and a second actuator 482. The second grid 490 is especially configured movable in the enclosure 410. During operation, at least part of the time the second grid 490 may in embodiments be configured upstream of the enclosure window 430 and downstream of the one or more objects 440. Especially, the second grid 490 may comprise a second grid structure 491 and second grid openings 492 (defined by the second grid structure 491). The second grid structure 491 may especially be configured to block part of the first device light 111 reflected at the one or more objects 440 and the second grid openings 492 may especially be configured to allow part of the first device light 111 reflected at the one or more objects 440 propagate through. In embodiments, the second actuator 482 may be configured to move the second grid 490 within the enclosure space 410. Especially, a control system 300 may be configured to control the second grid 490 in dependence of one or more of an input signal of a user interface, a sensor signal (of a sensor), and a timer.

FIG. 4b schematically depicts an embodiment, wherein the light generating system of FIG. 4a further comprises the first grid 460.

FIG. 5a schematically depicts a detailed embodiment of the light generating system 1000, wherein the enclosure window 430 comprises nano particles 435 having one or more dimensions selected from the range of 20-240 nm, more especially 40-180 nm, such as in the range of 60-150 nm, especially from the range 90-120 nm. Particle dimensions may be defined by smallest rectangular prisms circumscribing the respective particles, wherein such rectangular prism has a length D1, a width D2 and a height D3. Additionally or alternatively, particle dimensions may be defined by an equivalent spherical diameter D. In specific embodiments, the light generating system 1000 may further comprise a diffusor 470 configured downstream (relative to the propagation of the first device light 111) of the enclosure window 430. In alternative embodiments, the light generating system 1000 may further comprise a diffusor 470 configured directly upstream (relative to the propagation of the first device light 111) of the enclosure window 430. Especially, the diffusor 470 may be configured to diffusively transmit at least part of the first device light 111 and the optional second device light 121 reaching the diffusor 470. Such diffusor may enhance the user experience by varying a field of focus with a varying distance from the enclosure window 430.

FIG. 5b schematically depicts an embodiment of the first grid 460. The first grid 460 comprises a first grid structure 461 and first grid openings 462 defined by the first grid structure 461. The first grid structure 461 may especially be configured to block part of the first (and optional second) device light 111. The first grid openings 462 may especially be configured to allow first (and optional second) device light 111 to propagate through. The first grid structure 461 and the first grid openings 462 may in embodiments have any shape.

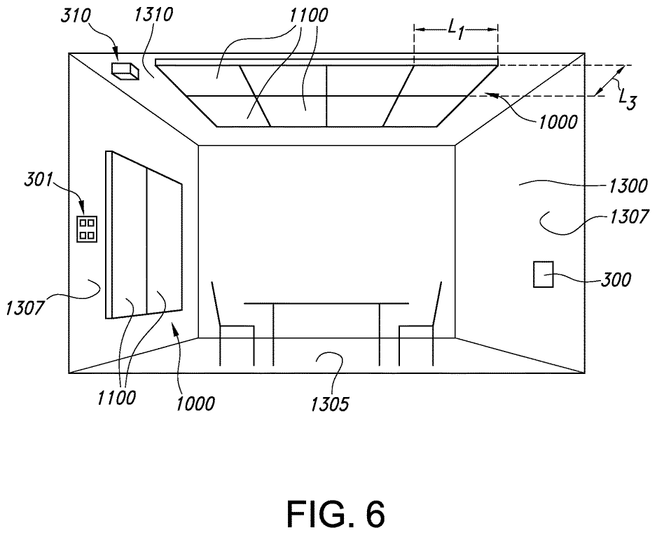

FIG. 6 schematically depicts a light generating system 1000 configured in a space 1300. Especially, the space 1300 may comprise one or more of a floor 1305, a wall 1307 and a ceiling 1310. In the depicted embodiment, the space 1300 further comprises the light generating system 1000. The light generating system 1000 may be one or more of suspended from the ceiling 1310 and attached to the wall 1307. In the depicted embodiment, the light generating system 1000 comprises an array of light generating units 1100. The light generating units may have a length L1 and a width L3. The space may further comprise one or more of a control system 300, a user interface 301, and a sensor 310. Reference 301 indicates a user interface which may be functionally coupled with the control system 300 comprised by or functionally coupled to the light generating system 1000. In embodiments, the space 1300 may comprise an office, a hospitality area, house, a station, or a vehicle.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising an enclosure unit, a first light generating device, and one or more objects, wherein:
the first light generating device is configured to generate first device light comprising visible light, wherein the visible light at least comprises blue light;
the enclosure unit comprises an enclosure wall and an enclosure window enclosing an enclosure space; wherein the enclosure wall is configured to absorb at least part of the first device light reaching the enclosure wall; and wherein the enclosure window is translucent for the first device light and scatters at least part of the blue light;
the first light generating device and the enclosure unit are configured such that the first device light is provided in the enclosure space, and part of the first device light escapes from the enclosure space via the enclosure window;
the one or more objects are configured in the enclosure space and are configured to reflect at least part of the first device light reaching the one or more objects;
the enclosure unit, the first light generating device, and the one or more objects are configured such that at least part of the first device light reaching the one or more objects only reaches the one or more objects via reflection at the enclosure window; and
wherein the enclosure unit further comprises a first blocking element, configured between the first light generating device and the one or more objects, and configured to prevent direct irradiation of the one or more objects with at least part of the first device light.

2. The light generating system according to claim 1, wherein the enclosure window comprises nano particles having one or more dimensions selected from the range of 40-180 nm and wherein the first device light comprises white type light; and wherein the enclosure wall is black.

3. The light generating system according to claim 1, wherein the first blocking element absorbs at least 50% of the first device light reaching the first blocking element perpendicularly.

4. The light generating system according to claim 1, wherein the first device light has a first optical axis, wherein the first optical axis and the enclosure window have a mutual first angle, wherein the first angle is selected from the range of 10-80°.

5. The light generating system according to claim 1, wherein the first light generating device and the enclosure window are configured such that at least 20% of a spectral power of the first device light reaching the enclosure window is transmitted through the enclosure window and at least 20% of the spectral power of the first device light reaching the enclosure window is reflected by the enclosure window.

6. The light generating system according to claim 1, wherein for the one or more objects applies one or more of: at least one of the objects is irregularly shaped, and three or more objects are not arranged in a regular pattern.

7. The light generating system according to claim 1, wherein at least one of the objects has the shape of a cloud.

8. The light generating system according to claim 1, wherein at least one of the objects comprises a wad of wool, crumbled paper, crumbled fabric, crumbled metal foil, or fibrous pads.

9. The light generating system according to claim 1, wherein the first light generating device has a controllable spectral power distribution of the first device light, including one or more different spectral power distributions of white type light; wherein the light generating system further comprises a control system, wherein the control system is configured to control the first light generating device in dependence of one or more of an input signal of a user interface, a sensor signal, and a timer.

10. The light generating system according to claim 1, further comprising a second light generating device, wherein:
the second light generating device is configured to generate second device light comprising visible light;
the second light generating device and the enclosure unit are configured such that the second device light is provided in the enclosure space, and part of the second device light escapes from the enclosure space via the enclosure window; and
the enclosure unit, the second light generating device, and the one or more objects are configured such that at least part of the second device light reaching the one or more objects only reaches the one or more objects directly.

11. The light generating system according to claim 1, further comprising a first grid configured downstream of the enclosure window or directly upstream of the enclosure window, wherein the first grid comprises a first grid structure and first grid openings, wherein the first grid structure is configured to block part of the first device light and wherein the first grid openings are configured to allow first device light propagate through.

12. The light generating system according to claim 1, further comprising a diffusor configured downstream of the enclosure window or directly upstream of the enclosure window, configured to diffusively transmit at least part of the first device light reaching the diffusor.

13. The light generating system according to claim 1, further comprising a first actuator, wherein:
at least one of the one or more objects is configured movable in the enclosure; and
the first actuator is configured to move the at least one of the one or more objects within the enclosure.

14. The light generating system according to claim 1, further comprising a second grid and a second actuator, and a control system, wherein:
the second grid is configured movable in the enclosure;
during operation, at least part of the time the second grid is configured upstream of the enclosure window and downstream of the one or more objects;
the second grid comprises a second grid structure and second grid openings, wherein the second grid structure is configured to block part of the first device light reflected at the one or more objects and wherein the second grid openings are configured to allow part of the first device light reflected at the one or more objects propagate through;
the second actuator is configured to move the second grid within the enclosure; and
the control system is configured to control the second grid in dependence of one or more of an input signal of a user interface, a sensor signal, and a timer.

15. A space comprising a ceiling, wherein the space further comprises the light generating system according to claim 1 suspended from the ceiling.
